(19) United States
(12) Patent Application Publication
(10) Pub. No.: US 2018/0058219 A1
(43) Pub. Date: Mar. 1, 2018

(54) ROTOR DISK HAVING SERRATIONS AND ROTOR

(71) Applicant: Siemens Aktiengesellschaft, Munich (DE)

(72) Inventors: Kevin Kampka, Mülheim a. d. Ruhr (DE); Karsten Kolk, Mülheim a.d. Ruhr (DE); Roger Matthews, Greer, SC (US)

(73) Assignee: Siemens Aktiengesellschaft, Munich (DE)

(21) Appl. No.: 15/251,421

(22) Filed: Aug. 30, 2016

(51) Int. Cl. F01D 5/02; F01D 5/30; F01D 5/32

(52) U.S. Cl. CPC F01D 5/02; F01D 5/3007; F01D 5/3053; F05D 2260/30; F05D 2220/32; F05D 2240/24; F01D 5/32

(57) ABSTRACT

A rotor disk of a rotor, in particular of a gas turbine, which has serrations, at least on one side, for torque transmission, having a plurality of teeth distributed over the circumference, the tooth flanks of which are aligned opposite with respect to a respective central plane, wherein the tooth flanks have a course that deviates from a radial direction in a cross section perpendicular to the rotor axis.

### FIELD OF INVENTION

The invention relates to a rotor disk for use with a rotor, wherein serrations for torque transmission are arranged at least on one side of the rotor disk. Here, the individual teeth of the serrations are embodied so as to be mirror-symmetrical with respect to a respective central plane.

### BACKGROUND OF INVENTION

Various embodiments of rotor disks are known from the prior art, these having different modes of construction for torque transmission. For example, rotor disks can be welded to one another. In most cases, however, the required ability for disassembly of the rotor for inspection of the rotor disks excludes a welded joint. In many cases, therefore, frictional flange joints, in which the rotor disks are connected to one another via flanges under a sufficient stress, are used. However, even if this embodiment is conducive to simple production of the rotor disks, it is found to be a disadvantage here that highly accurate cylinders to be fitted into one another are required for centering of the rotor disks relative to one another. Moreover, appropriate heating of one component and/or cooling of the other component is/are necessary for joining the rotor disks in the case of an interference fit.

Serrations are used as another type of joint with rotor disks. This has the particular advantage that the rotor can be readily disassembled and reassembled at any time and furthermore that no heat treatments are required for assembly and disassembly. Moreover, centering of the components relative to one another can likewise be achieved through an appropriate choice of serrations. In addition, serrations favor safe and reliable torque transmission by the rotor disk.

However, even if serrations allow reliable connection of rotor disks and, at the same time, allow simple and reliable assembly and disassembly, standard serrations have two disadvantages, depending on the method of use and the type of fastening:

Particularly when connecting rotor disks via flange joints, there is the problem of nonuniform surface pressure in the serrations. If adaptation of the serrations for optimum surface pressure in the tooth flanks when screwed together is performed to eliminate this defect, there is the countervailing disadvantage that centering cannot be ensured with high accuracy when fitting rotor disks together.

Furthermore, there is the problem, particularly in the case of thermally induced expansions in the rotor disks, that relative movements in the serrations of adjacent rotor disks can occur. Although standard serrations can ensure optimum centering in this case, uncontrolled expansion puts at risk the fastening of the rotor disks to one another, depending on the type of joint.

### SUMMARY OF INVENTION

It is therefore the object of the present invention to couple the rotor disks in an advantageous way such that centering is ensured while good load distribution in the tooth flanks is achieved and thermal expansions of one rotor disk do not lead to impermissible relative movements relative to the other rotor disk.

The stated object is achieved by an embodiment according to the invention following the teaching of the independent claim. Advantageous embodiments form the subject matter of the dependent claims.

In terms of its purpose, the rotor disk of the type in question is part of a rotor, which is used, in particular, in a gas turbine. Irrespective of this, the solution according to the invention can likewise be used with other rotors, e.g. those of a steam turbine. At the least, the rotor disk has serrations for torque transmission on one side. In this case, the serrations are formed by a plurality of teeth distributed over the circumference. In this arrangement, the extension of said teeth points toward the rotor axis. In corresponding fashion, the two tooth flanks of each tooth are aligned opposite with respect to a central plane through the tooth center and through the rotor axis. That is to say that the teeth each extend initially substantially radially with respect to the rotor axis when viewed along the rotor axis.

According to the invention, the connection of rotor disks by the use of serrations is now improved by the fact that the tooth flanks have a course which deviates from a radial direction. In this regard, the tooth is considered in a cross section perpendicular to the rotor axis through the tooth flanks, i.e. the resulting section curves through the two tooth flanks of each tooth. According to the invention, the section curves of the tooth flanks in cross section have a course which deviates from a radial direction. In this case, the exact course of the tooth flanks is in the first instance irrelevant.

By means of a first advantageous embodiment of the tooth flanks with a deviation from a radial course, adaptation to the stresses which arise during screwing is possible, on the one hand, thus ensuring that an advantageous surface pressure is achieved and yet that centering is ensured. With the requirement for as accurate as possible centering when assembling the serrations, it is obvious that completely uniform surface pressure over the entire serrations is impossible to achieve. On the contrary, adaptation to a uniform surface pressure and to the requirement for initial centering during assembly represents a compromise which in the best possible way reconciles the two requirements by means of a course deviating from the radial direction.

By means of a second advantageous embodiment of the tooth flanks with a deviation from a radial course, on the other hand, clamping of the rotor disks which can limit thermal relative movements is possible, that is to say impermissible relative movements are prevented within the serrations. In this regard, it is irrelevant whether the shaping of the serrations allows a certain relative movement between the two rotor disks as long as this does not result in any permanent damage to the joint between the rotor disks.

In the specific determination of the shaping of the tooth flanks, it is advantageous here to ensure that the locking portion does not prevent centering of the rotor disks relative to one another by means of the centering portion.

An advantageous rotor disk has an inner disk portion, which serves primarily for stabilization and load absorption, a central portion, on the front end of which the serrations are arranged, and an outer fastening portion. Arranged in the fastening portion in a manner distributed over the circumference is a plurality of blade retention grooves, which particularly preferably extend axially. This enables rotor blades to be mounted on the blade retention grooves.

A particularly advantageous rotor disk furthermore has an axially extending sleeve portion, on one end of which there is a connection flange. In this arrangement, the connection flange extends radially inward and/or outward from the sleeve portion. Here, provision is made for the serrations to be situated on the front face of the connection flange. In this case, the sleeve portion, together with the connection flange, advantageously forms part of the central portion.

In order to allow advantageous connection of rotor disks, provision is made here for there to be a plurality of fastening holes distributed over the circumference in the connection flange. This makes it possible to connect rotor disks to the connection flange by means of a screwed joint.

It is particularly advantageous if the tooth, i.e. that tooth tip of the respective tooth which faces away from the rotor disk, extends radially with respect to the rotor axis. Provision is furthermore advantageously made for the respective teeth of the serrations to be embodied symmetrically with respect to a central plane along the rotor axis. Here, the two section curves of the respective tooth are mirror-symmetrical with respect to a radial line.

The embodiment of the teeth or tooth flanks is in the first instance irrelevant as long as the tooth flanks have a course which deviates from the radial direction. However, it is particularly advantageous here if the teeth are divided into a centering portion and a locking portion adjoining the centering portion radially on the outside and/or radially on the inside. It is envisaged here that the tooth flanks extend substantially radially in the centering portion. The essential point is that, with the centering portion, centering of the components relative to one another is made possible even while fitting together rotor disks. In this arrangement, it is particularly advantageous if the serrations in the centering portion form Hirth-type serrations. In contrast, the tooth flanks in the locking portion extend differently from the course thereof in the centering portion. As a result of this, the tooth flanks, i.e. the section curves of the tooth flanks in cross section, have a smaller or larger (or decreasing or increasing) spacing relative to one another, when viewed in a cross section perpendicular to the rotor axis, than would correspond to the substantially radial course thereof in the centering portion.

The particularly advantageous embodiment of the serrations divided into a centering portion and into a locking portion with the centering portion allows optimum centering of rotor disks relative to one another even during the joining of the components.

Moreover, on the one hand, the locking portion allows optimum adaptation to the deformations which occur during fastening and thus an optimum surface pressure in the tooth flanks.

On the other hand, the locking portion allows advantageous coupling of adjacent rotor disks at the serrations, with the result that there is coupling of the rotor disks in the event of thermally induced radial movements of one rotor disk relative to the adjacent rotor disk in such a way that the radial movement of one advantageous connection flange leads to the concomitant movement of the connection flange coupled radially via the serrations. Damage to possible connection elements by thermal relative movements is thus prevented.

The embodiment of the tooth flanks in the locking portion is in the first instance irrelevant, wherein, in a first advantageous variant, the tooth flanks when viewed in cross section, i.e. the section curves, once again have a linear course. That is to say that, when viewed in cross section, an opening angle between the tooth flanks, i.e. the section curves, which are advantageously arranged in mirror-symmetry relative to one another, in the locking portion is different from the opening angle in the centering portion. In a second advantageous variant, it is possible to provide the tooth flanks in the locking portion with an arc-shaped course. Moreover, a combination of a linear and an arc-shaped course is obviously possible.

If the tooth tips of the individual teeth of the serrations are viewed in a longitudinal section through the tooth tip and the rotor axis, especially where the tooth flanks are advantageously embodied in mirror symmetry with respect to the central plane, and if a constant shape of the tooth tips is chosen, or if an assumed constant tooth tip is regarded as an extension or a shortening of the tooth flanks, the division into a central portion and a locking portion leads to a substantially radial course of the tooth tips in the centering portion and to an arc-shaped course of the tooth tips and/or to a course of the tooth tips with a slope which differs from the direction in the centering portion, i.e. to a linear radial-axial course of the tooth tips, in the locking portion.

As regards the centering portion, provision can be made, in a first advantageous embodiment, for the tooth tips to extend radially with respect to the rotor axis. In the case of a particularly advantageous radial course of the center of the toothing, a constant tooth tip leads to an outwardly increasing height of the teeth and thus to a course of the tooth tip which differs slightly from the radial course. In the case of an outer radius R of the centering portion and a tooth height h, the deviation from the radial direction is, to a good approximation, α=arcsin(h/2×R). In the case of a rotor disk of a gas turbine, the slope of the tooth tip in the centering portion with a radial course of the center of the toothing is approximately 0.2 degrees to 0.8 degrees, similarly to known embodiments of serrations (extending continuously “without a kink”). In a third embodiment, provision can be made for the tooth root between two teeth to extend radially with respect to the rotor axis, wherein the slope of the tooth tip relative to the radial direction doubles in a manner corresponding to the second embodiment. It is obvious that the slope of the tooth tip chosen can likewise be in a range between the first embodiment and the third embodiment.

It is particularly advantageous if the shaping of the tooth flanks in the locking portion is used to ensure concomitant movement of the adjacent flange of the serrations in the case of thermal relative movement. It is therefore particularly advantageous if the tooth tips in the locking portion (which are constant or assumed to be constant) slope by at least 0.25 degrees relative to the centering portion. A slope of at least 0.5 degrees is particularly advantageously chosen here.

On the other hand, the feasibility of producing the serrations and the accuracy required during this process have to be considered. The slope should therefore advantageously not exceed 15 degrees. It is particularly advantageous if the slope in the locking portion relative to the centering portion is at most 5 degrees.

In the case of an arc-shaped course of the constant tooth tip or theoretical tooth tip assumed to be constant, the slope of a tangent to the course of the tooth tip is used to determine the angular deviation with respect to the rectilinear course in the centering portion.

Starting from a rotor disk according to the invention, it is possible to form a rotor according to the invention which comprises at least one first rotor disk and at least one second rotor disk, which both have serrations. Provision is made here for the serrations of the first rotor disk to interact with the serrations of the second rotor disk and to bring about centering of the rotor disks relative to one another and allow transmission of torques. In this case, at least one rotor disk has serrations in accordance with the above description.

It is particularly advantageous here if both rotor disks are embodied with serrations in accordance with the above description. It is obvious that, in this embodiment, the tooth-flank course deviating from the radial direction must be embodied in the opposite way, when considering the respective serrations, to make the corresponding coupling possible. That is to say that, if a slope away from the rotor disk is chosen in the locking portion of the first rotor disk, a slope toward the rotor disk must obviously be present on the second rotor disk.

To connect the two rotor disks, it is particularly preferable to use fastening bolts passing through the fastening holes in the first connection flange of the first rotor disk and/or the second connection flange of the second rotor disk. Provision can also be made for screws to be screwed through one connection flange into threaded holes in the other connection flange. It is thereby possible to achieve particularly advantageous connection of the rotor disks, wherein damage to the fastening bolts due to thermal relative movement can be prevented by means of the embodiment according to the invention of the serrations.

To achieve reliable centering of the rotor disks relative to one another, provision is particularly advantageously made for centering to be brought about by the centering portion during the mounting of the rotor disks on one another, wherein, in the unfastened state, there is at least a minimum gap in the locking portion between the first tooth flanks of the serrations of the first rotor disk and the second tooth flanks of the serrations of the second rotor disk.

The formation of the gap between the sets of serrations, in particular in the region of the locking portion, can be accomplished in various ways. Assuming that a centering portion without a gap is present, it is obvious that either an additional free space is necessary at the transition between the centering portion and the locking portion or that there is a gradual transition from the centering portion to the locking portion. For example, an annular groove or some other recess that leaves the tooth flanks free can be provided between the centering portion and the locking portion. Provision can also be made for the teeth of one set of serrations to have a smaller outside radius between the centering portion and the locking portion than the inside radius of the teeth of the other set of serrations situated opposite, when viewed in a longitudinal section.

Irrespective of the specific embodiment, it is advantageous, at least after a transition from the centering portion to the locking portion, to provide a gap of at least 0.01 mm in the locking portion. However, it is particularly advantageous here if the locking portion forms a gap of at least 0.1 mm. This ensures the centering of the rotor disks relative to one another by the centering portion without being influenced by the locking portion.

It is furthermore advantageous if the gap in the locking portion is at most 2 mm. The choice of a gap of at most 2 mm ensures that effective locking of the flanges of the adjacent rotor disks relative to one another takes place and thus that a connection of the rotor disks, e.g. by means of the fastening bolts, is not damaged. It is particularly advantageous here if the gap in the locking portion is at most 0.2 mm.

As regards the specific embodiment of the gap between the serrations of the first rotor disk and the serrations of the second rotor disk in the locking portion, there are various possibilities for implementation, wherein, in a first advantageous embodiment, a gap which increases continuously outward is used. In this case, provision can be made, for example, for a minimum gap of 0.01 mm to be provided adjoining the centering portion and a transition to the locking portion, said gap increasing to 2 mm, for example, in the course of the locking portion.

This embodiment of the serrations of the adjacent rotor disks makes possible, in particular, a gradual increase in the pressure in the joint in the case of relative radial thermal expansions, thus ensuring that the respectively adjacent flange is subjected to load continuously in the radial direction. It should be noted that, although the additional loading in the radial direction is not desired, this does achieve the aim of ensuring that the connection between the rotor disks, in particular by means of screwed flange joints, is not damaged.

If a continuously increasing gap is used, it is possible, in another particularly advantageous embodiment, to bring about variation of the gap width around the rotor axis. For example, it is advantageously possible to choose a larger increase in the gap in the region of the fastening bolts than in the region between two fastening bolts. A possible compensation through the deformation of the rotor disks when the fastening bolts are tightened is thus achieved.

In another particularly advantageous embodiment, the gap chosen is substantially constant over the course thereof. Such an embodiment makes it possible, in a particularly advantageous way, for the rotor disks to move relative to one another by a certain amount, owing to thermal expansions for example, while there is direct blocking of a further radial movement of one connection flange relative to the adjacent connection flange at a limiting value involving contact of the tooth flanks in the locking portion. Damage to the fastening means when a critical limit is reached is thereby prevented in an effective manner. In this context, it is possible, in a further embodiment, for the gap to expand slightly in the unstressed state, with the course of the gap being substantially constant after the stressing of the rotor disks.

### BRIEF DESCRIPTION OF THE DRAWINGS

In the figures below, two illustrative embodiments of a rotor and, associated with this, two illustrative embodiments of the tooth flanks are depicted diagrammatically. Of the figures:

FIG. 1 shows a first illustrative embodiment of a rotor having a widening gap in the serrations;

FIG. 2 shows a second illustrative embodiment of a rotor having a constant gap in the serrations;

FIG. 3 shows a longitudinal section through the serrations;

FIG. 4 shows a cross section through two teeth of the serrations in FIG. 3;

FIG. 5 shows another longitudinal section through an alternative set of serrations with an arc-shaped course;

FIG. 6 shows a cross section through two teeth of the serrations in FIG. 5.

### DETAILED DESCRIPTION OF INVENTION

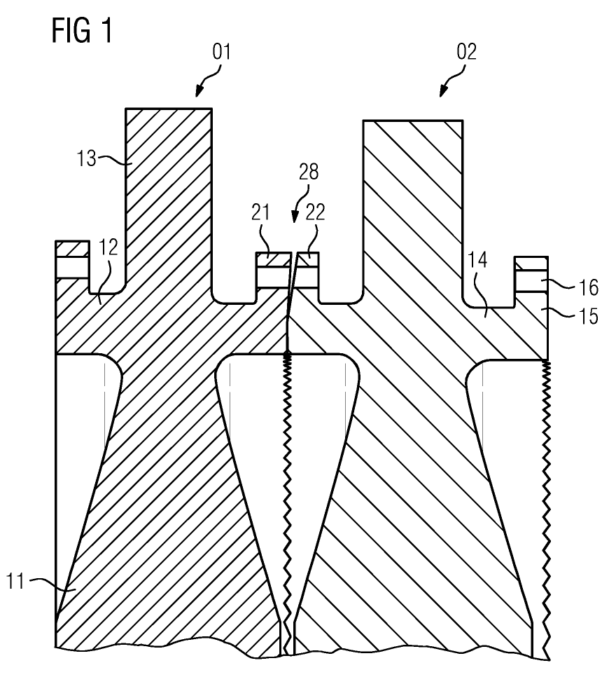

A first illustrative embodiment of a rotor according to the invention is depicted diagrammatically in FIG. 1. Two disks 01 and 02, shown by way of example, which 01, 02 are connected to one another by serrations 21, 22, can be seen. The rotor disks 01, 02 each have a disk portion 11, a central portion 12 and a fastening portion 13. Respective sleeve portions 14, on the ends of which there are respective connection flanges 10, are arranged in the central portion 12 on both sides of the center. There are respective fastening holes 16 in the connection flange 15, said holes being distributed over the circumference. The two rotor disks 01, 02 are connected via the sets of serrations 21, 22 present on the front face of the connection flange 15. In this illustrative embodiment, it is envisaged that the serrations 21, 22 of the rotor disks 01, 02 have a centering portion 41 and a locking portion 42, wherein a gap 28 which 28 widens continuously, starting from the central portion 41, is formed in the locking portion 42.

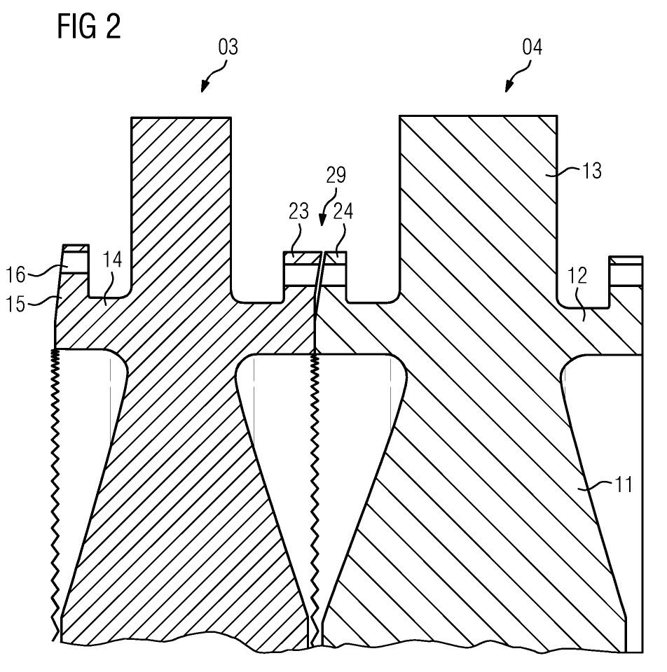

Another illustrative embodiment relating to this is shown by FIG. 2, likewise having two rotor disks 03 and 04, which 03, 04 correspondingly have a disk portion 11, a central portion 12 and a fastening portion 13. Once again, the rotor disks are connected via respective connection flanges 15, which 15 are arranged on sleeve portions 14. Once again, there are fastening holes 16 distributed over the circumference in the connection flanges 15. Once again, the rotor disks 03, 04 are connected to one another via sets of serrations 23, 24, which 23, 24 are divided into a centering portion 41 and a locking portion 42. In contrast to the previous illustrative embodiment, it is now envisaged that the gap 29 in the locking portion 42 between the sets of serrations 23, 24 is substantially constant.

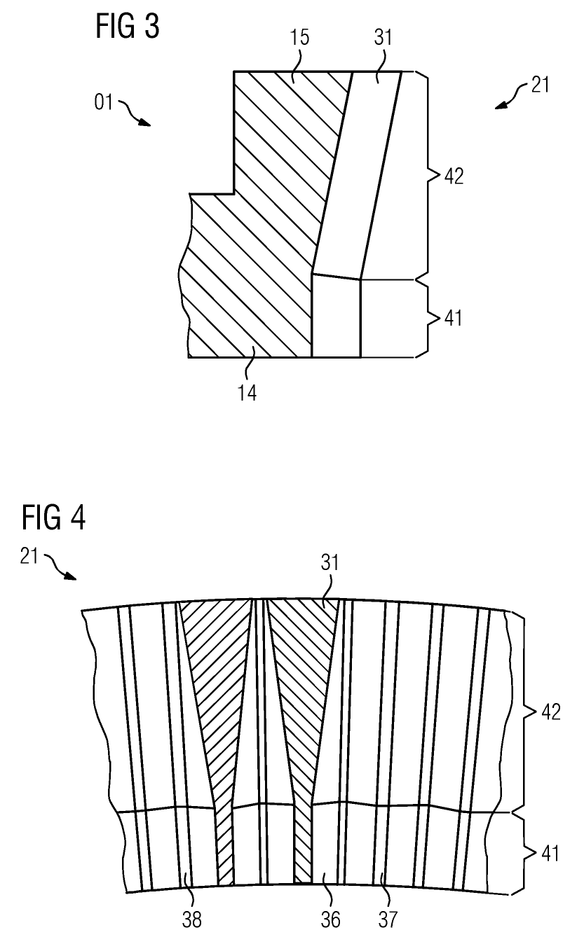

A tooth 31 of set of serrations 21 is then depicted diagrammatically in detail in longitudinal section through the first rotor disk 01 in FIG. 3. It shows the sleeve portion 14 with the connection flange 15, on the front face of which the set of serrations 21 having the tooth 31 is situated. The tooth 31 is divided into the radially inner centering portion 41 and the outer locking portion 42. Here, it is envisaged that the tooth flanks or tooth 31 extends radially in the centering portion 41. In contrast, the tooth in the locking portion 42 extends on a slope relative to the radial direction.

In this regard, FIG. 4 depicts diagrammatically the embodiment of set of serrations 21 in cross section through two teeth 32 perpendicularly to the rotor axis. Once again, it shows the centering portion 41 and, radially on the outside, the locking portion 42. The tooth flanks 36 of the respective teeth 31 are embodied symmetrically with respect to a central plane through the rotor axis. In corresponding fashion—when considering this view of set of serrations 21 along the rotor axis—the tooth tips 37 and likewise the respective tooth root 38 between two teeth 31 extend in a radial direction. If the section through the teeth 31 is then considered, it is immediately apparent that the tooth flanks 36 in the central portion 41 have the undiminished radial course. In contrast, the section curves of the cross section through the teeth 31 widen relative to one another in the locking portion 42 and thus have a course which deviates from the radial direction.

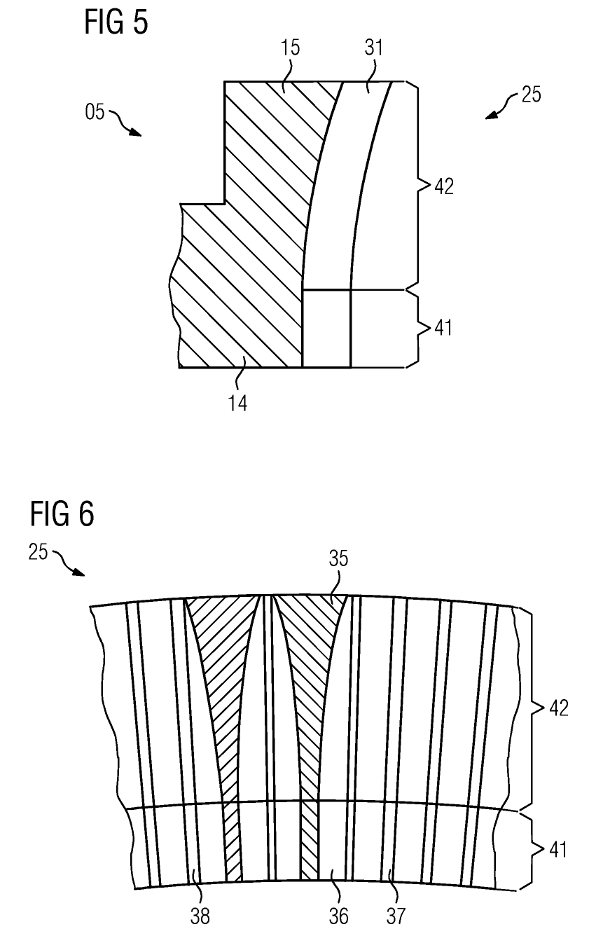

An alternative illustrative embodiment of the shaping of the teeth 31 is then depicted diagrammatically in FIG. 5. Once again, the sleeve portion 14 with the connection flange 15, on the front face of which set of serrations 25 is situated, can be seen in longitudinal section. The teeth 31 thereof once again have a centering portion 41 with a radial course and a locking portion 42. In contrast to the previous illustrative embodiment in FIG. 3, the teeth 31 have an arc-shaped course when viewed in longitudinal section.

In this regard, FIG. 6, similarly to FIG. 4, diagrammatically depicts a cross section through set of serrations 25, through two teeth 35. The tooth flanks 36 of the teeth 35 are formed in a correspondingly mirror-symmetrical fashion relative to a central plane through the rotor axis. In corresponding fashion, the tooth tips 37 and the respective tooth root 38 extend undiminished in a radial direction when the serrations are considered in this view along the rotor axis. However, the tooth flanks 36 sectioned in the cross section, i.e. the section curves, have an arc-shaped course which deviates from the radial direction in the locking portion 42.

1. A rotor disk of a rotor comprising:
serrations, at least on one side, for torque transmission, comprising a plurality of teeth distributed over the circumference, the tooth flanks of which are aligned opposite with respect to a respective central plane,
wherein the tooth flanks have a course that deviates from a radial direction in a cross section perpendicular to the rotor axis.

2. The rotor disk as claimed in claim 1, further comprising:
an inner disk portion and a central portion, on the front end of which the serrations are arranged, and an outer fastening portion, which has a plurality of blade retention grooves distributed over the circumference.

3. The rotor disk as claimed in claim 1, further comprising:
an axially extending sleeve portion and a connection flange, which extends radially inward and/or outward on said sleeve portion and on the front face of which the serrations are arranged.

4. The rotor disk as claimed in claim 3, further comprising:
a plurality of fastening holes distributed over the circumference in the connection flange.

5. The rotor disk as claimed in claim 1,
wherein the tooth tip of each tooth extends radially with respect to the rotor axis; and/or
wherein the two tooth flanks of each tooth are mirror-symmetrical with respect to the central plane.

6. The rotor disk as claimed in claim 1,
wherein the teeth have a centering portion, the tooth flanks of which extend substantially radially and a locking portion adjoining radially on the outside and/or on the inside, wherein the spacing of the tooth flanks relative to one another increases or decreases in the locking portion, deviating in this respect from the centering portion.

7. The rotor disk as claimed in claim 6,
wherein the tooth flanks have an arc-shaped course in cross section in the locking portion; and/or
wherein the tooth flanks have a linear course in cross section in the locking portion.

8. The rotor disk as claimed in claim 6,
wherein the tooth tips extend substantially radially in the centering portion and in an arc shape and/or in a linear radial-axial direction at an angle to the centering portion in the locking portion, when viewed in longitudinal section.

9. The rotor disk as claimed in claim 8,
wherein the tooth tips in the locking portion slope by at least 0.25°, relative to the centering portion; and/or
wherein the tooth tips in the locking portion slope by at most 15°, relative to the centering portion.

10. A rotor, comprising:
a first rotor disk as claimed in claim 1, and
a second rotor disk,
wherein the sets of serrations of the rotor disks are arranged so as to engage in one another.

11. The rotor as claimed in claim 10,
wherein the rotor disks are connected by means of a plurality of fastening bolts passing through the fastening holes in the first connection flange and/or the second connection flange.

12. The rotor as claimed in claim 10,
wherein, when the first tooth flanks are resting on the second tooth flanks in the centering portion, there is a gap between the first tooth flanks and the second tooth flanks in the locking portion.

13. The rotor as claimed in claim 12,
wherein the gap in the locking portion is at least 0.01 mm, and/or at most 2 mm.

14. The rotor as claimed in claim 12,
wherein the gap becomes continuously larger toward the outside; and/or
wherein the gap is substantially constant; and/or
wherein the gap is larger in the region of the fastening bolts than in the region between two fastening bolts.

15. The rotor disk as claimed in claim 1,
wherein the rotor disk is of a rotor of a gas turbine.

16. The rotor disk as claimed in claim 2,
wherein the plurality of blade retention grooves comprise axially extending blade retention grooves, distributed over the circumference.

17. The rotor disk as claimed in claim 6,
wherein the tooth flanks form a set of Hirth-type serrations.

18. The rotor disk as claimed in claim 9,
wherein the tooth tips in the locking portion slope by at least 0.5°, linearly, relative to the centering portion; and/or
wherein the tooth tips in the locking portion slope by at most 5°, linearly, relative to the centering portion.

19. A rotor of a gas turbine, comprising:
a first rotor disk and a second rotor disk, both rotor disks as claimed in claim 1,
wherein the sets of serrations of the rotor disks are arranged so as to engage in one another.

20. The rotor as claimed in claim 13,
wherein the gap in the locking portion is at least 0.1 mm, and/or at most 0.2 mm.
